(19) United States
(12) Patent Application Publication
(10) Pub. No.: US 2013/0224437 A1
(43) Pub. Date: Aug. 29, 2013

(54) APPARATUS FOR MANUFACTURING SYNTHETIC WOOD HAVING STRIPES AND THE METHOD THEREOF AND THE SYNTHETIC WOOD OF THE SAME

(71) Applicants: Jong Sung Park, Daejeon (KR); Jung II Son, Gyeonggi-do (KR)

(72) Inventors: Jong Sung Park, Daejeon (KR); Jung II Son, Gyeonggi-do (KR)

(73) Assignee: LG Hausys, Ltd., Seoul (KR)

(21) Appl. No.: 13/883,712

(22) PCT Filed: Nov. 9, 2011
(86) PCT No.: PCT/KR2011/008523

§ 371 Date: May 6, 2013

(30) Foreign Application Priority Data
Nov. 10, 2010 (KR) 10-2010-0111283

(51) Int. Cl. B29C 47/00; B44F 9/02

(52) U.S. Cl. CPC B29C 47/003; B44F 9/02
USPC 428/151; 425/131.1; 264/75

(57) ABSTRACT

Disclosed is an apparatus for manufacturing synthetic wood having spripes, and the method thereof and the syn-thetic wood of the same. The apparatus includes a main extruder comprising a hopper through which a raw material is injected, a heating cylinder which is disposed at a lower side of the hopper so as to melt the raw material, and an extrusion screw which ex-trudes the melted raw material in the heating cylinder; an uneven wood grain forming part which injects the melted different colors raw material in a transverse direction (or diagonal direction) so as to form an uneven stripe pattern in the transverse direction (or diagonal direction) as well as a length direction of synthetic wood and at an outer surface and an inner portion thereof; and a mold which forms the extruded material introduced through the uneven wood grain forming part into an extruded product of synthetic wood.

### TECHNICAL FIELD

The present invention relates to a synthetic wood, and particularly to an apparatus for manufacturing synthetic wood having spripes, in which an injector (or pump) for injecting a different colored material in a transverse direction (or diagonal direction) of the synthetic wood is interlocked with a main extruder for contrinuous extrusion-molding so that even and uneven stripe patterns such as growth rings of wood can be formed at an inner portion as well as an outer surface of the molded synthetic wood in the transverse direction (or diagonal direction) and a length direction thereof, and the method thereof and the synthetic wood of the same.

### BACKGROUND ART

Recently, there have been various studies on synthetic wood having the texture and pattern of natural wood. Since the synthetic wood contains a large amount of wood flour, it has similar apperance and properties to natural wood and it is typically manufacture by injection or extrusion molding.

The plastic raw material used in the injection or extrusion molding is polyolefine such as polyethylene and polypropylene. In case of polyolefine, it is a nontoxic and Eco-friendly material, and thus it is proper to use in the synthetic wood, and the synthetic wood is manufactured by injection or extrusion molding. In an injection-molded product, because desired shapes or wood grain patterns are formed upon the injection molding, it is possible to provide the texture of wood without a secondary operation such as printing and painting.

In case of an extrusion-molded product, it can be manufacture as a similar products to lumbers, timbers, rectangular lumbers and the like, and thus it can be used as a construction material. Generally, the synthetic wood has some advantages in that it has lower absorbable property than the natural wood and also it is not decomposed. Further, since the extrusion-molded product has relatively row foaming magnitude and also it has a high density outer surface, it has a high strength and thus it can be treated by various physical processings such as pegging and planning.

Because such synthetic wood has a excellent strength and physical properties and also it is Eco-friendly and renewable, its market share is undergoing rapid growth in the field of new materials replacing the natural wood, and thus various synthetic wood products are being developed.

Meanwhile, in the most of conventional synthetic woods, patterns are formed by mechanical after processings or sometimes by using pigments.

FIG. 1 is a schematic front view of an apparatus for forming stripes on a surface of an extrusion-molded product through a conventional extrusion-molding method, and FIG. 2 is a view showing synthetic wood in which stripes are formed at its outer surface and inner portion.

Referring to FIG. 1, a conventional apparatus for manufacturing synthetic wood having stripes includes a main extruder 10, a sub extruder 20 and a mold 30.

In the main extruder 10, a raw material is injected through a hopper 11, and a heating cylinder 12 is provided at a lower side of the hopper, and a heater 13 is provided at an outer circumference of the heating cylinder 12 so as to supply heat to the heating cylinder 12 and thus heat the raw material.

Further, a hydraulic motor 14 is provided at a rear end of the heating cylinder 12, and an extrusion screw (not shown) disposed in the heating cyinder 12 is rotated by the hyraulic motor 14 so that the raw material melted in the heating cylinder 12 is mixed and compressed and then supplied to an extrusion head (not shown) so as to extrude the thermoplastic resin into a desired shape.

In the sub extruder 20, a raw material is injected through a hopper 21, and a heating cylinder 22 is provided at a lower side of the hopper, and a heater 23 is provided at an outer circumference of the heating cylinder 22 so as to supply heat to the heating cylinder 22.

Further, a hydraulic motor 24 is provided at a rear end of the heating cylinder 22, and an extrusion screw (not shown) disposed in the heating cyinder 22 is rotated by the hyraulic motor 24 so that the raw material melted in the heating cylinder 22 is supplied to an extrusion head (not shown) so as to extrude the raw material into a desired shape.

The melted raw material extruded by the extrusion screws of the main extruder 10 and the sub extruder 20 is discharged through the mold (i.e., die) 30 and then manufactured as a final product through after treatments such as drying and cutting.

Herein, in the sub extruder 20, while the melted raw material is extruded through the extrusion head, an amount of injected raw material is constant with the passing of time. Thus, there is a problem in that a stripe pattern 41 is formed only in a length direction of the synthetic wood 40.

Therefore, it is required to develop new synthetic wood having the stripe patterns formed in a transverse direcetion (or diagonal direction) as well as the length direction of the synthetic wood at an inner portion as well as an outer surface thereof.

### DISCLOSURE OF INVENTION

### Technical Problem

An object of the present invention is to provide an apparatus for manufacturing synthetic wood having spripes, in which the stripe patterns can be formed at an inner portion as well as an outer surface of the molded synthetic wood in a transverse direcetion (or diagonal direction) as well as a length direction thereof, and the method thereof and the synthetic wood of the same.

Another object of the present invention is to provide an apparatus for manufacturing synthetic wood having spripes, in which even and uneven stripe patterns such as growth rings of wood can be formed by controlling a raw material injection period of an injector (or pump), and the method thereof and the synthetic wood of the same.

### Solution to Problem

To achieve the object of the present invention, the present invention provides an apparatus for manufacturing synthetic wood having spripes, including a main extruder comprising a hopper through which a raw material is injected, a heating cylinder which is disposed at a lower side of the hopper so as to melt the raw material, and an extrusion screw which extrudes the melted raw material in the heating cylinder; an uneven wood grain forming part which injects the melted different colors raw material in a transverse direction (or diagonal direction) so as to form an uneven stripe pattern in the transverse direction (or diagonal direction) as well as a length direction of synthetic wood and at an outer surface and an inner portion thereof; and a mold which forms the extruded material introduced through the uneven wood grain forming part into an extruded product of synthetic wood.

Preferably, the uneven wood grain forming part comprises an injector (or pump) which injects a melted different colored raw material thorugh an extrusion head in the transverse direction (or diagonal direction) of the synthetic wood; and an injector controller which controls a raw material injection period of the injector (or pump).

Further, the present invention provides a method of manufacturing synthetic wood having spripes, including melting a raw material injected through a hopper of a main extruder in a heating cylinder, and supplying and extruding the melted raw material to an extrusion head through an extrusion screw; controlling an injector (or pump) through an injector controller while a different colored material is injected through the injector (or pump) in a transverse direction (or diagonal direction) of the synthetic wood, and thus controlling an injection period of the different colored raw material; and forming the extruded material introduced through the main extruder and the uneven wood grain forming part into an extruded product of synthetic wood.

Preferably, the injector controller controls the temporary and irregular resin injection period through the control of the injector (or pump) so as to form the uneven strip pattern on the synthetic wood.

### Advantageous Effects of Invention

The apparatus and method for manufacturing synthetic wood having spripes according to the present invention has some effects as follows:

First, it is possible to for the stripe patterns at an inner portion as well as an outer surface of the molded synthetic wood and in the transverse direcetion (or diagonal direction) and the length direction thereof through the injector (or pump) for injecting a different colored material in a transverse direcetion (or diagonal direction) of the synthetic wood, which is interlocked with the main extruder for contrinuous extrusion-molding.

Second, it is possible to form the even and uneven stripe patterns by controlling the raw material injection period of the injector (or pump).

### BRIEF DESCRIPTION OF DRAWINGS

The above and other objects, fretures and advantages of the present invention will become apparaent from the following description of preferred embodiments given in conjunction with the accompany drawings, in which:

FIG. 1 is a schematic front view of an apparatus for forming stripes on a surface of an extrusion-molded product through a conventional extrusion-molding method.

FIG. 2 is a view showing synthetic wood in which stripes are formed at its outer surface and inner portion.

FIG. 3 is a schematic front view of an apparatus for manufacturing synthetic wood having spripes according to the present invention.

FIG. 4 is a view showing synthetic wood in which stripes are formed at its outer surface and inner portion by the apparatus of FIG. 3.

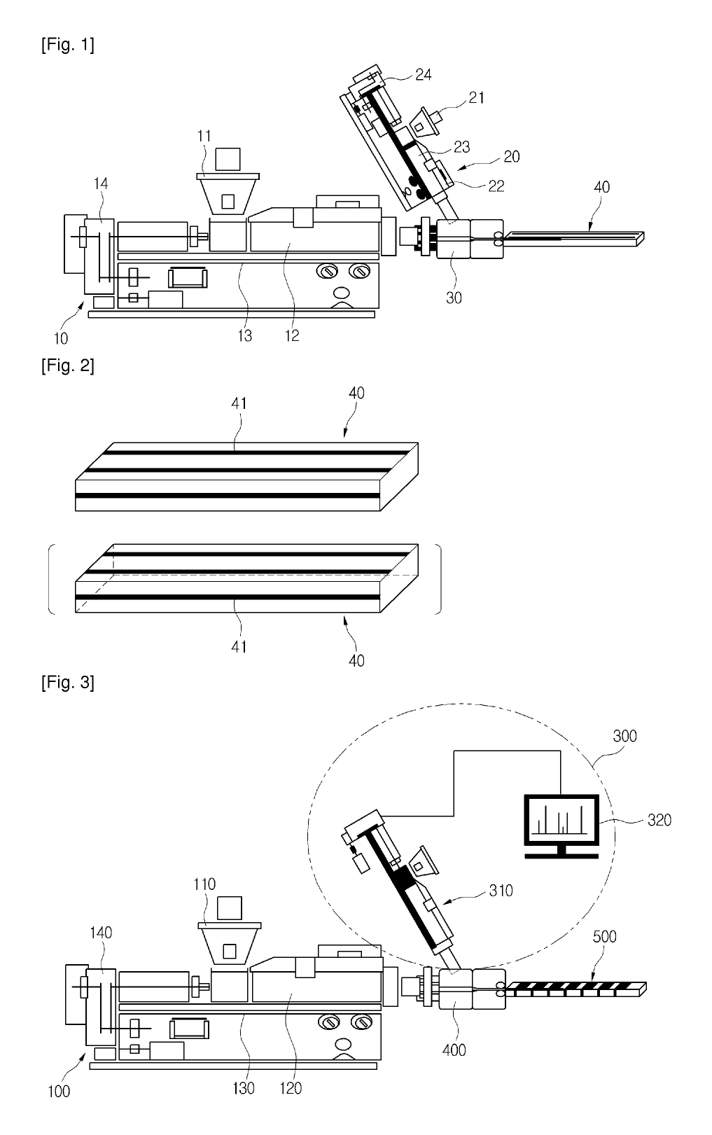

### DETAILED DESCRIPTION OF MAIN ELEMENTS

100: main extruder 110: hopper

120: heating cylinder 130: heater

140: hydraulic motor 300: uneven wood grain forming part

310: injector (or pump) 320: injector controller

400: mold 500: synthetic wood

### BEST MODE FOR CARRYING OUT THE INVENTION

Hereinafter, the embodiments of the present invention will be described in detail.

Hereinafter, the terms and words used in the description as described below are not limited to the typical or dictionary definition, and they can be interpreted as proper meanings and definitions consistent with the technical ideas.

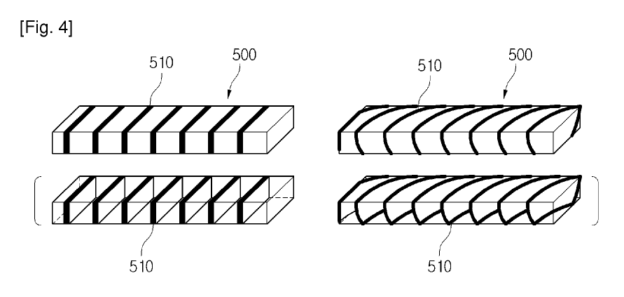

FIG. 3 is a schematic front view of an apparatus for manufacturing synthetic wood having spripes according to the present invention, and FIG. 4 is a view showing synthetic wood in which stripes are formed at its outer surface and inner portion by the apparatus of FIG. 3.

Referring to FIG. 3, the apparatus for manufacturing synthetic wood having spripes according to the present invention includes a main extruder 100, an uneven wood grain forming part 300 and a mold 400.

In the main extruder 100, a raw material is injected through a hopper 110, and a heating cylinder 120 is provided at a lower side of the hopper, and a heater 130 is provided at an outer circumference of the heating cylinder 120 so as to supply heat to the heating cylinder 120 and thus heat the raw material.

Further, a hydraulic motor 140 is provided at a rear end of the heating cylinder 120, and an extrusion screw (not shown) disposed in the heating cyinder 120 is rotated by the hyraulic motor 140 so that the raw material melted in the heating cylinder 120 is mixed and compressed and then supplied to an extrusion head (not shown) so as to extrude the thermoplastic resin into a desired shape.

The uneven wood grain forming part 300 includes an injector (or pump) 310, and an injector controller 320.

The injector controller 320 is provided with a program for controlling an raw material injecting operation of the injector (or pump) 310 so as to control temporary and irregular resin injection period through the control of the injector (or pump) 310.

The injector (or pump) 310 functions to inject a different colored raw material (resin) through an extrusion head in a transverse direction (or diagonal direction) of synthetic wood 500 and thus to form a desired pattern in an extruded product. Meanwhile, in case that it is controlled by an injector controller 320 so that an amount of the injected raw material is not constant with the passing of time, i.e., a temporary and uneven amount of the different colored raw material is injected, it is possible to form an uneven stripe pattern 510 such as wood grain in the transverse direction (or diagonal direction) as well as the length direction of synthetic wood 500.

The melted raw material discharged through the main extruder 100 and the uneven wood grain forming part 300 is discharged through the mold (i.e., die) 400 and then manufactured as a final product through after treatments such as drying and cutting.

Referring to FIG. 4, it can be understood that the uneven stripe pattern 510 is formed in the transverse direction (or diagonal direction) as well as the length direction of synthetic wood 500 and at an outer surface and an inner portion thereof.

### INDUSTRIAL APPLICABILITY

The apparatus and method for manufacturing synthetic wood having spripes according to the present invention has some effects as follows:

It is possible to for the stripe patterns at an inner portion as well as an outer surface of the molded synthetic wood and in the transverse direcetion (or diagonal direction) and the length direction thereof through the injector (or pump) for injecting a different colored material in a transverse direcetion (or diagonal direction) of the synthetic wood, which is interlocked with the main extruder for contrinuous extrusion-molding.

It is also possible to form the even and uneven stripe patterns by controlling the raw material injection period of the injector (or pump).

While the present invention has been described with respect to the specific embodiments, it will be apparent to those skilled in the art that various changes and modifications may be made without departing from the spirit and scope of the invention as defined in the following claims.

1. An apparatus for manufacturing synthetic wood having spripes, comprising:
a main extruder comprising a hopper through which a raw material is injected, a heating cylinder which is disposed at a lower side of the hopper so as to melt the raw material, and an extrusion screw which extrudes the melted raw material in the heating cylinder;
an uneven wood grain forming part which injects the melted different colors raw material in a transverse direction (or diagonal direction) so as to form an uneven stripe pattern in the transverse direction (or diagonal direction) as well as a length direction of synthetic wood and at an outer surface and an inner portion thereof; and
a mold which forms the material introduced through the main extruder and the uneven wood grain forming part into an extruded product of synthetic wood.

2. The apparatus according to claim 1, wherein the uneven wood grain forming part comprises an injector (or pump) which injects a melted different colored raw material thorugh an extrusion head in the transverse direction (or diagonal direction) of the synthetic wood; and an injector controller which controls a raw material injection period of the injector (or pump).

3. A method of manufacturing synthetic wood having spripes, comprising: melting a raw material injected through a hopper of a main extruder in a heating cylinder, and supplying and extruding the melted raw material to an extrusion head through an extrusion screw;
controlling an injector (or pump) through an injector controller while a different colored material is injected through the injector (or pump) in a transverse direction (or diagonal direction) of the synthetic wood, and thus controlling an injection period of the different colored raw material; and
forming the extruded material introduced through the main extruder and the uneven wood grain forming part into an extruded product of synthetic wood.

4. The method according to claim 3, wherein the injector controller controls the temporary and irregular resin injection period through the control of the injector (or pump) so as to form the uneven strip pattern on the synthetic wood.

5. A synthetic wood having stripes, which is manufacture by the method according to claim 3.

6. A synthetic wood having stripes, which is manufacture by the method according to claim 4.
